(19) United States
(12) Patent Application Publication
(10) Pub. No.: US 2015/0138301 A1
(43) Pub. Date: May 21, 2015

(54) APPARATUS AND METHOD FOR GENERATING TELEPRESENCE

(71) Applicant: Electronics and Telecommunications Research Institute, Daejeon (KR)

(72) Inventors: Yong-Wan KIM, Daejeon (KR); Dong-Sik JO, Daejeon (KR); Hye-Mi KIM, Daejeon (KR); Jin-Ho KIM, Daejeon (KR); Ki-Hong KIM, Daejeon (KR)

(21) Appl. No.: 14/548,801

(22) Filed: Nov. 20, 2014

(30) Foreign Application Priority Data
Nov. 21, 2013 (KR) 10-2013-0142125

(51) Int. Cl. H04N 7/15; H04N 13/02; H04N 5/232

(52) U.S. Cl. CPC H04N 7/157; H04N 5/23238; H04N 13/0203
USPC 348/14.04

(57) ABSTRACT

An apparatus and method for generating telepresence are disclosed. The apparatus for generating telepresence includes a visual information sensing unit that is mounted on a robot which is located in a remote location, and senses visual information corresponding to a view of the robot, a tactile information sensing unit that is mounted on the robot, and senses tactile information in the remote location, an environmental information sensing unit that is mounted on the robot, and senses environmental information which is information for a physical environment of the remote location, a robot communication unit that receives movement information for movement performed by a user who is located in a space separated from the remote location in correspondence to the visual information, the tactile information, and the environmental information, and a robot control unit that drives the robot based on the movement information.

### CROSS REFERENCE TO RELATED APPLICATION

This application claims the benefit of Korean Patent Application No. 10-2013-0142125, filed Nov. 21, 2013, which is hereby incorporated by reference in its entirety into this application.

### BACKGROUND OF THE INVENTION

1. Technical Field

The present invention relates generally to an apparatus and method for generating telepresence. More particularly, the present invention relates to a method for enabling a user to have the sensation of being virtually present in a remote location after wearing a wide field-of-view Head Mounted Display (HMD) based on remote images, tactile sensations, and 4-Dimensional (4D) effects information which are acquired through a movable control device in the remote location, and to an apparatus and method for generating telepresence capable of providing virtual trips, virtual viewings, and virtual experiences in the future.

2. Description of the Related Art

Recently, real-time video calls have been provided using a mobile phone or a web cam. However, since a small screen or a stationary display which is far from the vision of a user is used, the sensation of immersion is deteriorated, and thus it is difficult for the user to have the sensation of being present in a remote location.

In addition, in existing HMDs, it has been attempted to provide the sensation of being present in a virtual environment through a graphics screen which is rendered in real time. However, there is a disadvantage in that reality is not enough to provide the sensation of being actually present in the remote location.

Accordingly, with the development of wide field-of-view HMDs, tactile sensing technology, and stereoscopic cameras having wide angles, it is necessary to provide a method for enabling a user to have the sensation of being virtually present in the remote location after wearing a wide field-of-view HMD based on remote images, tactile sensations, and 4D effects information which are acquired through a movable control device in the remote location, and an apparatus and method for generating telepresence capable of providing virtual trips, virtual viewings, and virtual experiences in the future. Korea Patent Application Publication No. 10-2011-0093683 discloses a related technology.

### SUMMARY OF THE INVENTION

Accordingly, the present invention has been made keeping in mind the above problems occurring in the prior art, and an object of the present invention is to enable a user to have the sensation of being virtually present in a remote location after wearing a wide field-of-view Head Mounted Display (HMD) based on remote images, tactile sensations, and 4-Dimensional (4D) effects information which are acquired in the remote location, and to enable the user to interact with a person in the remote location in such a way that a robot in the remote location equally mimics the action of the user, thereby making it possible to provide the sensation that the local user is present in the remote location.

In addition, another object of the present invention is to enable the provision of virtually mixed reality experiences which are difficult to undergo in a real environment by mixing, visualizing, and simulating virtual objects in addition to actual objects in the remote location.

In accordance with an aspect of the present invention, there is provided an apparatus for generating telepresence including a visual information sensing unit mounted on a robot located in a remote location, and configured to sense visual information corresponding to a view of the robot, a tactile information sensing unit mounted on the robot, and configured to sense tactile information in the remote location, an environmental information sensing unit mounted on the robot, and configured to sense environmental information which is information for a physical environment of the remote location, a robot communication unit configured to receive movement information for movement performed by a user who is located in a space separated from the remote location in correspondence to the visual information, the tactile information, and the environmental information, and a robot control unit configured to drive the robot based on the movement information.

The visual information sensing unit may be a stereoscopic camera having a wide angle, which stereoscopically captures images of the remote location at a wide angle by controlling a viewing direction of the robot in correspondence to a movement direction of the user's head.

The environmental information sensing unit may sense the environmental information including at least one of winds, sounds, smells, and smoke in the remote location.

The robot communication unit may receive the movement information from a movement information sensing unit that senses the movement performed by the user in correspondence to the visual information, the tactile information, and the environmental information.

The movement information sensing unit may include a gyro-based sensing unit for sensing the movement information through at least one of gyro sensors which are mounted on a body of the user.

The movement information sensing unit may include a camera-based sensing unit for sensing the movement information through an infrared camera or a depth camera located in the vicinity of the user.

The movement information sensing unit may include an interface unit for acquiring a space for movement of feet of the user through a treadmill located beneath the feet of the user.

The robot communication unit may transmit the visual information, the tactile information, and the environmental information.

In accordance with another aspect of the present invention, there is provided an apparatus for generating telepresence including a visual information acquisition unit worn by a user, and configured to acquire visual information corresponding to a view of a robot from the robot which is located in a remote location separated from a place where the user is present, a tactile information acquisition unit worn by a user, and configured to acquire tactile information in the remote location from the robot, and an environmental information acquisition unit configured to be present in a space where the user is located, and to acquire environmental information which is information for a physical environment of the remote location from the robot, wherein the user understands a status of the remote location based on the visual information, the tactile information, and the environmental information.

The apparatus may further include a fusion information generation unit configured to generate fusion information which is acquired by fusing at least one of the visual information, the tactile information, and the environmental information with virtual information generated based on a simulated virtual object, wherein the user understands the status of the remote location based on the fusion information.

The visual information acquisition unit may be a wide field-of-view Head Mounted Display (HMD).

The visual information acquisition unit may transmit movement information for a movement direction of a user's head, thus allowing the robot to control a viewing direction of the robot based on the movement information.

The environmental information acquisition unit may acquire the environmental information including at least one of winds, sounds, smells, and smoke in the remote location.

In accordance with a further aspect of the present invention, there is provided a method for generating telepresence including sensing, by a visual information sensing unit, visual information corresponding to a view of a robot which is located in a remote location, sensing, by a tactile information sensing unit, tactile information in the remote location, sensing, by an environmental information sensing unit, environmental information which is information for a physical environment of the remote location, receiving, by a robot communication unit, movement information for movement performed by a user who is located in a space separated from the remote location in correspondence to the visual information, the tactile information, and the environmental information, and driving, by a robot control unit, the robot based on the movement information.

Sensing the visual information may include stereoscopically capturing images of the remote location at a wide angle by controlling a viewing direction of the robot in correspondence to a movement direction of the user's head.

Sending the environmental information may include sensing the environmental information including at least one of winds, sounds, smells, and smoke in the remote location.

Receiving the movement information may include receiving, by the robot communication unit, the movement information from a movement information sensing unit that senses the movement performed by the user in correspondence to the visual information, the tactile information, and the environmental information.

Receiving the movement information may include receiving the movement information from the movement information sensing unit that includes a gyro-based sensing unit for sensing the movement information through at least one of gyro sensors mounted on a body of the user.

Receiving the movement information may include receiving the movement information from the movement information sensing unit that includes a camera-based sensing unit for sensing the movement information through an infrared camera or a depth camera located in the vicinity of the user.

Receiving the movement information may include receiving the movement information from the movement information sensing unit that includes an interface unit for acquiring a space for movement of feet of the user through a treadmill located beneath the feet of the user.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are system configuration diagrams showing an apparatus for generating telepresence according to the present invention;

FIG. 3 is a block diagram illustrating the telepresence generating apparatus according to the present invention;

FIG. 4 is a block diagram illustrating a movement information sensing unit of the telepresence generating apparatus according to the present invention;

FIG. 5 is a flowchart illustrating a telepresence generating method according to the present invention; and

FIG. 6 is an embodiment of the present invention implemented in a computer system.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below.

The embodiments of the present invention are intended to fully describe the present invention to a person having ordinary knowledge in the art to which the present invention pertains. Accordingly, the shapes, sizes, etc. of components in the drawings may be exaggerated to make the description clearer.

In addition, when components of the present invention are described, terms, such as first, second, A, B, (a), and (b), may be used. The terms are used to only distinguish the components from other components, and the natures, sequences or orders of the components are not limited by the terms.

Hereinafter, the configuration of a system of a telepresence generating apparatus according to the present invention and the configuration and detailed operation of the telepresence generating apparatus according to the present invention will be described with reference to the accompanying drawings.

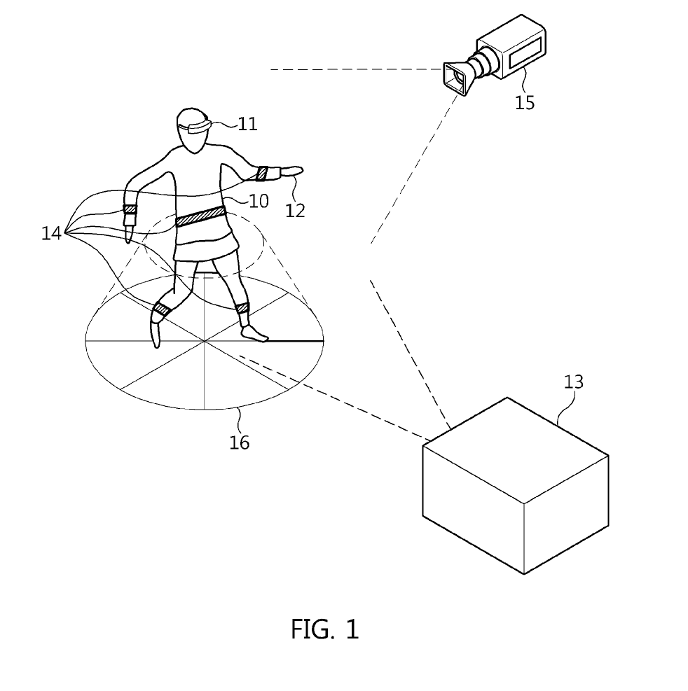

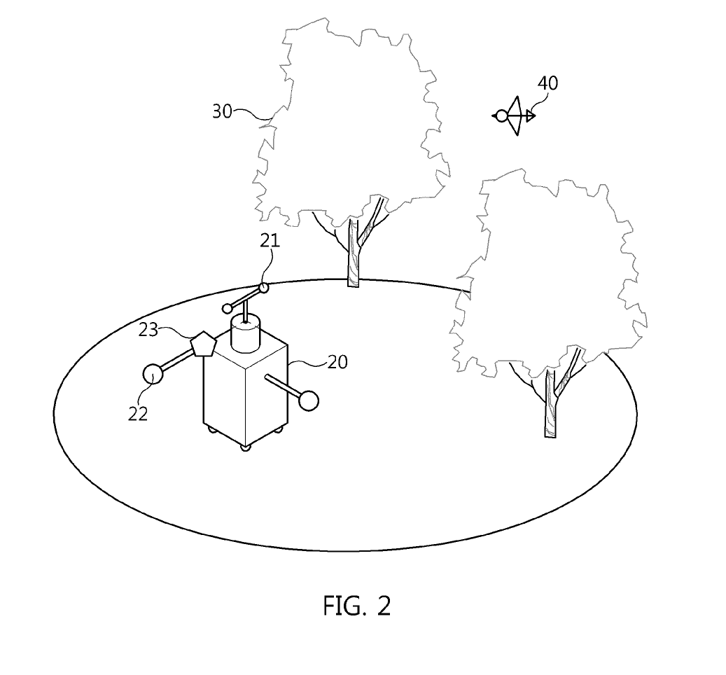

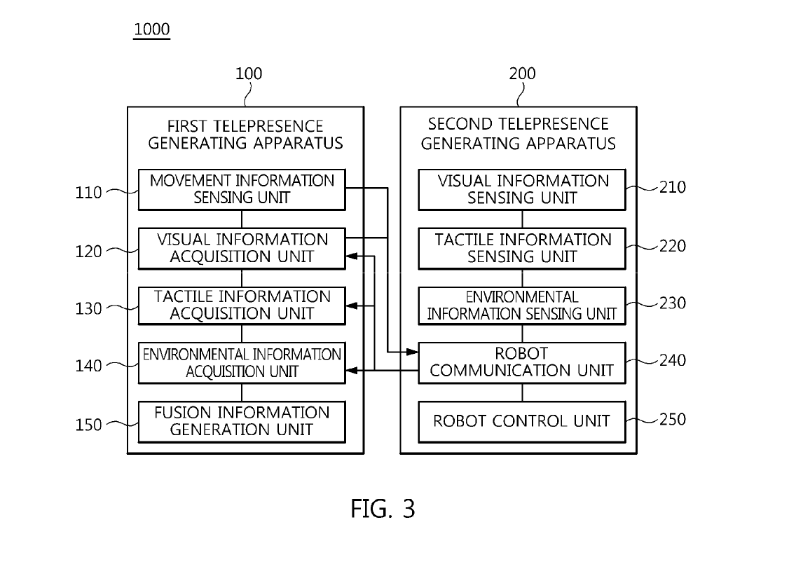

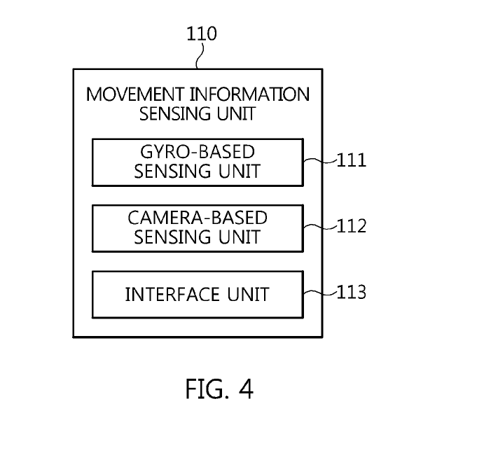

FIGS. 1 and 2 are system configuration diagrams showing an apparatus for generating telepresence according to the present invention. FIG. 3 is a block diagram illustrating the telepresence generating apparatus according to the present invention. FIG. 4 is a block diagram illustrating a movement information sensing unit of the telepresence generating apparatus according to the present invention.

Referring to FIGS. 1 and 2, the telepresence generating apparatus according to the present invention may be described while a space is divided into a space where a user is located (hereinafter referred to as a “user space”) and a space which is separated from the user space and in which a robot is located (hereinafter referred to as a “remote location space”).

FIG. 1 is a diagram illustrating the figure of a user who is present in the user space, and FIG. 2 is a diagram illustrating the figure of a robot which is present in the remote location space.

In addition, referring to FIG. 3, the telepresence generating apparatus according to the present invention is divided into a first telepresence generating apparatus 100 which is operated in the user space and a second telepresence generating apparatus 200 which is operated in the remote location space, and each of the first and second telepresence generating apparatuses means the telepresence generating apparatus according to the present invention.

Referring to both FIGS. 1 and 2, a user 10 is present in the user space, and may feel as if he or she is present in the remote location through a visual information acquisition unit 11. That is, the user may see images, which are captured by a robot 20 present in the remote location, in the user space.

In addition, the user may perceive tactile sensations in the remote location by wearing a tactile information acquisition unit 12 around a hand of the user. More specifically, the tactile sensations sensed by the robot 20, which is present in the remote location, are transmitted to the user 10.

In addition, the user may perceive a physical environment of the remote location where the robot 20 is present through an environmental information acquisition unit 13 which is present in the space where the user is present. Here, the physical environment is a concept which includes at least one of the winds, sounds, smells, and smoke which are generated in the remote location.

Accordingly, the user 10 may sense information about an environment in the remote location despite the fact that the user is not located in the remote location.

In addition, there are movement information sensing units 14 which are mounted on the body parts, such as arms and legs, of the user 10, or a movement information sensing unit 15 which senses the movement of the user 10 using a camera (an infrared camera or a depth camera) which is present in the space where the user 10 is located. The reason for this is to control the movement of the robot 20, which is present in the remote location, similarly to the movement of the user 10 by detecting the movement of the user 10.

That is, design is made such that the robot 20 walks in the direction, in which the user 10 walks, and the robot 20 sits down, lies down, or runs if the user 10 sits down, lies down, or runs.

In addition, in order to secure a space where the user 10 moves, a treadmill, which is located beneath the feet of the user, may be utilized in the user space.

When the treadmill is used, there is an advantage in that a movement space for the user may be secured as the user 10 does not actually move and moves in place.

In addition, referring to FIG. 2, there is a visual information sensing unit 21 which is mounted on the robot 20 and senses visual information corresponding to the view of the robot 20. The visual information sensing unit 21 performs a function of capturing images of the remote location, and is configured to equally move depending on the movement or the direction of the visual information acquisition unit 11 which is worn by the user 10.

Accordingly, the images of the remote location may be observed based on the directions and angles in which the user 10 who is separated far from the robot 20 rotates his or her head.

In addition, there is a tactile information sensing unit 22 which senses tactile information generated when the robot 20 comes into contact with an actual object 30 or a virtual object 40 in the remote location, and an environmental information sensing unit 23 which senses the environmental information (winds, sounds, smells, and smoke) in the remote location is mounted on the robot 20.

The detailed configuration and function of an object, which is mounted on the user 10 or the robot 20 or which is present in the user space or the remote location space, and the environment of the remote location space will be described later.

Hereinafter, the telepresence generating apparatus according to the present invention will be described in detail with reference to FIG. 3.

Referring to FIG. 3, a first telepresence generating apparatus 100 according to the present invention includes a movement information sensing unit 110, a visual information acquisition unit 120, a tactile information acquisition unit 130, an environmental information acquisition unit 140, and a fusion information generation unit 150.

More specifically, the movement information sensing unit 110 of the first telepresence generating apparatus 100 senses movement information for movement performed by the user in correspondence to the visual information, the tactile information and the environmental information. The visual information acquisition unit 120 is worn by the user and acquires visual information corresponding to the view of the robot from the robot located in a remote location which is separated from a location where the user is located. The tactile information acquisition unit 130 is worn by the user and acquires the tactile information in the remote location from the robot. The environmental information acquisition unit 140 is present in the space where the user is located and acquires the environmental information which is information for the physical environment of the remote location from the robot. The user understands the status of the remote location based on the visual information, the tactile information, and the environmental information.

Here, the first telepresence generating apparatus 100 may further include the fusion information generation unit 150 that generates fusion information which is acquired by fusing at least one of the visual information, the tactile information, and the environmental information with virtual information generated based on a simulated virtual object, and the user may understand the status of the remote location based on the fusion information.

More specifically, referring to FIG. 4, the movement information sensing unit 110 may include a gyro-based sensing unit 111 that senses the movement information through at least one of the gyro sensors that are mounted on the body of the user, and a camera-based sensing unit 112 that senses the movement information through an infrared camera or a depth camera which is located in the vicinity of the user.

In addition, the movement information sensing unit 110 may further include an interface unit 113 that acquires a space for movement of the feet of the user through a treadmill which is located beneath the feet of the user.

The gyro-based sensing unit 111 may be realized by mounting the gyro sensors on the arms, legs, or waist of the user.

The visual information acquisition unit 120 is worn by the user and performs a function of acquiring the visual information corresponding to the view of the robot from the robot which is located in the remote location separated from the place where the user is present.

Here, the visual information acquisition unit may be implemented as a wide field-of-view Head Mounted Display (HMD), and may be configured to transmit the movement information for the movement direction of the user's head to the robot, thus allowing the robot to control the viewing direction of the robot based on the movement information.

In addition, the tactile information acquisition unit 130 is configured in a form which is worn by the user, and performs a function of acquiring the tactile information in the remote location from the robot.

In addition, the environmental information acquisition unit 140 is present in the space where the user is located, and performs a function of acquiring the environmental information, which is information about the physical environment of the remote location, from the robot.

More specifically, the environmental information acquisition unit 140 may acquire the environmental information which includes at least one of the winds, sounds, smells, and smoke in the remote location. That is, the environmental information acquisition unit 140 acquires the environmental information which is sensed by the robot.

In addition, the fusion information generation unit 150 performs a function of generating the fusion information which is acquired by fusing at least one of the visual information, the tactile information, and the environmental information with the virtual information generated based on the simulated virtual object.

More specifically, the fusion information may be generated by combining original visual information with the simulated virtual object, may be generated by incorporating tactile sensations of the virtual object into original tactile information, and may also be generated by incorporating the environmental information of the virtual object into original environmental information.

As described above, when the fusion information is generated, the user understands the status of the remote location based on the fusion information. That is, it is characterized that the user may interact with the simulated virtual object in addition to actual objects which are present in the remote location.

For example, a virtual robot which falls down after being struck by missile or a virtual animal which goes around in an actual remote environment may be assumed, and it is possible to provide sensations as if the user rides a huge robot.

Continuing to refer to FIG. 3, the second telepresence generating apparatus 200 according to the present invention includes a visual information sensing unit 210, a tactile information sensing unit 220, an environmental information sensing unit 230, a robot communication unit 240 and a robot control unit 250.

More specifically, the visual information sensing unit 210 of the second telepresence generating apparatus 200 according to the present invention is mounted on the robot located in the remote location, and senses the visual information corresponding to the view of the robot. The tactile information sensing unit 220 is mounted on the robot and senses the tactile information in the remote location. The environmental information sensing unit 230 is mounted on the robot, and senses the environmental information which is information for the physical environment of the remote location. The robot communication unit 240 receives the movement information for movement performed by the user who is located in the space separated from the remote location in correspondence to the visual information, the tactile information, and the environmental information. The robot control unit drives the robot based on the movement information.

More specifically, the visual information sensing unit 210 is mounted on the robot which is located in the remote location, and performs a function of sensing the visual information corresponding to the view of the robot.

Here, the visual information sensing unit 210 may be a stereoscopic camera having a wide angle, which stereoscopically captures the images of the remote location at a wide angle by controlling the viewing direction of the robot in correspondence to the movement direction of the user's head.

In addition, the tactile information sensing unit 220 is mounted on the robot, and performs a function of sensing the tactile information in the remote location.

In addition, the environmental information sensing unit 230 is mounted on the robot, and performs a function of the sensing environmental information which is information for the physical environment of the remote location.

More specifically, the environmental information sensing unit 230 may sense the environmental information which includes at least one of winds, sounds, smells, and smoke in the remote location.

The robot communication unit 240 performs a function of receiving the movement information for movement performed by the user who is located in the space separated from the remote location in correspondence to the visual information, the tactile information, and the environmental information.

In addition, the robot communication unit 240 performs a function of transmitting the visual information, which is sensed by the visual information sensing unit 210, to the visual information acquisition unit 120, transmitting the tactile information, which is sensed by the tactile information sensing unit 220, to the tactile information acquisition unit 130, and transmitting the environmental information, which is sensed by the environmental information sensing unit 230, to the environmental information acquisition unit 140.

More specifically, the robot communication unit 240 receives the movement information from the movement information sensing unit 110 that senses the movement information for the movement performed by the user in correspondence to the visual information, the tactile information, and the environmental information.

Here, the movement information sensing unit 110 may include a gyro-based sensing unit 111 that senses the movement information through at least one of the gyro sensors that are mounted on the body of the user, and a camera-based sensing unit 112 that senses the movement information through an infrared camera or a depth camera located in the vicinity of the user.

In addition, the movement information sensing unit 110 may further include an interface unit that acquires a space for movement of the feet of the user through a treadmill which is located beneath the feet of the user.

Hereinafter, a telepresence generating method according to the present invention will be described. Repeated descriptions of content of the technique which is the same as the telepresence generating apparatus according to the present invention will be omitted.

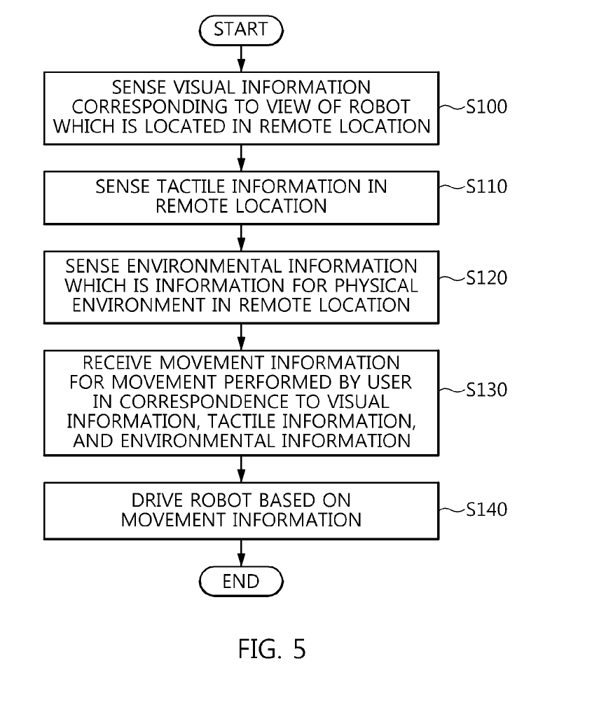

FIG. 5 is a flowchart illustrating the telepresence generating method according to the present invention.

Referring to FIG. 5, the telepresence generating method according to the present invention includes sensing visual information corresponding to the view of a robot, which is located in a remote location, by the visual information sensing unit at step S100; sensing tactile information in the remote location by the tactile information sensing unit at step S110; sensing environmental information, which is information for a physical environment of the remote location, by the environmental information sensing unit at step S120; receiving movement information for movement performed by the user who is located in a space separated from the remote location in correspondence to the visual information, the tactile information, and the environmental information by the robot communication unit at step S130; and driving the robot based on the movement information by the robot control unit at step S140.

Here, sensing the visual information at step S100 may include stereoscopically capturing the images of the remote location at a wide angle by controlling the viewing direction of the robot in correspondence to the movement direction of the user's head.

In addition, sensing the environmental information at step S120 may include sensing the environmental information which includes at least one of winds, sounds, smells, and smoke in the remote location, and receiving the movement information at step S130 may include receiving the movement information from the movement information sensing unit that senses the movement performed by the user in correspondence to the visual information, the tactile information, and the environmental information by the robot communication unit.

Here, receiving the movement information at step S130 may include receiving the movement information from the movement information sensing unit that includes a gyro-based sensing unit which senses the movement information through at least one of gyro sensors which are mounted on the body of the user, and may include receiving the movement information from the movement information sensing unit that includes the camera-based sensing unit which senses the movement information through an infrared camera or a depth camera which is located in the vicinity of the user.

That is, when the movement information is received, the movement information which is sensed by the movement information sensing unit is received. Here, the movement information may be used to acquire user movement information using at least one of the gyro sensors, the infrared camera, and the depth camera.

In addition, receiving the movement information at step S130 may include receiving the movement information from the movement information sensing unit that includes the interface unit which acquires a space for movement of the feet of the user through a treadmill which is located beneath the feet of the user.

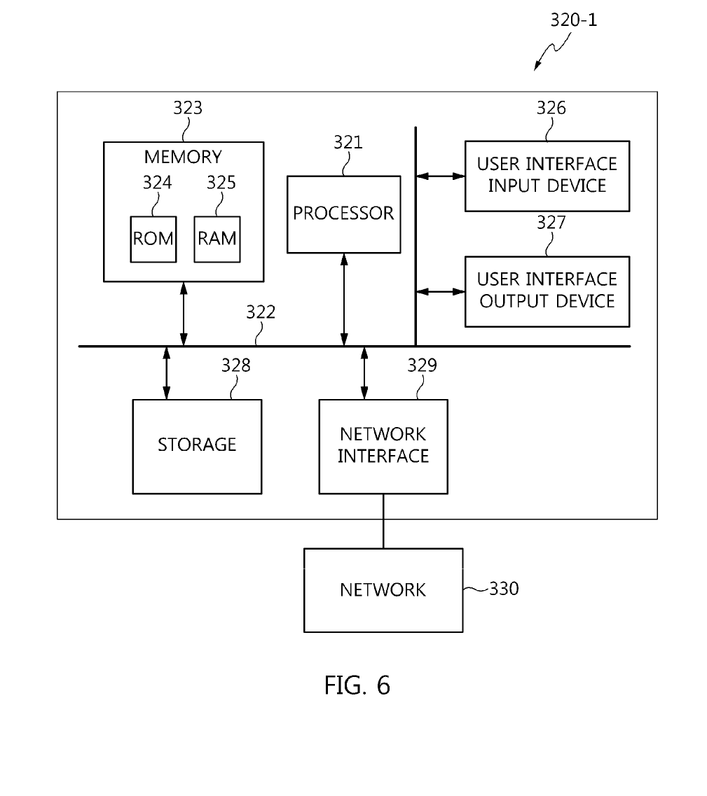

FIG. 6 is an embodiment of the present invention implemented in a computer system.

Referring to FIG. 6, an embodiment of the present invention may be implemented in a computer system, e.g., as a computer readable medium. As shown in in FIG. 6, a computer system 320-1 may include one or more of a processor 321, a memory 323, a user interface input device 326, a user interface output device 327, and a storage 328, each of which communicates through a bus 322. The computer system 320-1 may also include a network interface 329 that is coupled to a network 330. The processor 321 may be a central processing unit (CPU) or a semiconductor device that executes processing instructions stored in the memory 323 and/or the storage 328. The memory 323 and the storage 328 may include various forms of volatile or non-volatile storage media. For example, the memory may include a read-only memory (ROM) 324 and a random access memory (RAM) 325.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

According to the present invention, there is an advantage in that a user may have the sensation of being virtually present in a remote location after wearing an HMD based on remote images, tactile sensations, and 4D effects information which are acquired in the remote location, and may interact with a person in the remote location in such a way that a robot in the remote location mimics the action of the user as it is, thereby making it possible to provide the sensation that the local user is present in the remote location.

In addition, according to the present invention, there is another advantage in that it is possible to provide virtually mixed reality experiences, which are difficult to undergo in a real environment, by mixing, visualizing, and simulating the virtual objects in addition to the actual objects in the remote location.

As described above, the apparatus and method for generating telepresence according to the present invention are not limited and applied to the configurations and operations of the above-described embodiments, but all or some of the embodiments may be selectively combined and configured so that the embodiments may be modified in various ways.

What is claimed is:

1. An apparatus for generating telepresence comprising:
a visual information sensing unit mounted on a robot located in a remote location, and configured to sense visual information corresponding to a view of the robot;
a tactile information sensing unit mounted on the robot, and configured to sense tactile information in the remote location;
an environmental information sensing unit mounted on the robot, and configured to sense environmental information which is information for a physical environment of the remote location;
a robot communication unit configured to receive movement information for movement performed by a user who is located in a space separated from the remote location in correspondence to the visual information, the tactile information, and the environmental information; and
a robot control unit configured to drive the robot based on the movement information.

2. The apparatus of claim 1, wherein the visual information sensing unit is a stereoscopic camera having a wide angle, which stereoscopically captures images of the remote location at a wide angle by controlling a viewing direction of the robot in correspondence to a movement direction of the user's head.

3. The apparatus of claim 1, wherein the environmental information sensing unit senses the environmental information including at least one of winds, sounds, smells, and smoke in the remote location.

4. The apparatus of claim 1, wherein the robot communication unit receives the movement information from a movement information sensing unit that senses the movement performed by the user in correspondence to the visual information, the tactile information, and the environmental information.

5. The apparatus of claim 4, wherein the movement information sensing unit comprises a gyro-based sensing unit for sensing the movement information through at least one of gyro sensors which are mounted on a body of the user.

6. The apparatus of claim 4, wherein the movement information sensing unit comprises a camera-based sensing unit for sensing the movement information through an infrared camera or a depth camera located in the vicinity of the user.

7. The apparatus of claim 4, wherein the movement information sensing unit comprises an interface unit for acquiring a space for movement of feet of the user through a treadmill located beneath the feet of the user.

8. The apparatus of claim 1, wherein the robot communication unit transmits the visual information, the tactile information, and the environmental information.

9. An apparatus for generating telepresence comprising:
a visual information acquisition unit worn by a user, and configured to acquire visual information corresponding to a view of a robot from the robot which is located in a remote location separated from a place where the user is present;
a tactile information acquisition unit worn by a user, and configured to acquire tactile information in the remote location from the robot; and
an environmental information acquisition unit configured to be present in a space where the user is located, and to acquire environmental information which is information for a physical environment of the remote location from the robot,
wherein the user understands a status of the remote location based on the visual information, the tactile information, and the environmental information.

10. The apparatus of claim 9, further comprising:
a fusion information generation unit configured to generate fusion information which is acquired by fusing at least one of the visual information, the tactile information, and the environmental information with virtual information generated based on a simulated virtual object,
wherein the user understands the status of the remote location based on the fusion information.

11. The apparatus of claim 9, wherein the visual information acquisition unit is a wide field-of-view Head Mounted Display (HMD).

12. The apparatus of claim 9, wherein the visual information acquisition unit transmits movement information for a movement direction of a user's head, thus allowing the robot to control a viewing direction of the robot based on the movement information.

13. The apparatus of claim 9, wherein the environmental information acquisition unit acquires the environmental information including at least one of winds, sounds, smells, and smoke in the remote location.

14. A method for generating telepresence comprising:
sensing, by a visual information sensing unit, visual information corresponding to a view of a robot which is located in a remote location;
sensing, by a tactile information sensing unit, tactile information in the remote location;
sensing, by an environmental information sensing unit, environmental information which is information for a physical environment of the remote location;
receiving, by a robot communication unit, movement information for movement performed by a user who is located in a space separated from the remote location in correspondence to the visual information, the tactile information, and the environmental information; and
driving, by a robot control unit, the robot based on the movement information.

15. The method of claim 14, wherein sensing the visual information comprises stereoscopically capturing images of the remote location at a wide angle by controlling a viewing direction of the robot in correspondence to a movement direction of the user's head.

16. The method of claim 14, wherein sensing the environmental information comprises sensing the environmental information including at least one of winds, sounds, smells, and smoke in the remote location.

17. The method of claim 14, wherein receiving the movement information comprises receiving, by the robot communication unit, the movement information from a movement information sensing unit that senses the movement performed by the user in correspondence to the visual information, the tactile information, and the environmental information.

18. The method of claim 17, wherein receiving the movement information comprises receiving the movement information from the movement information sensing unit that includes a gyro-based sensing unit for sensing the movement information through at least one of gyro sensors mounted on a body of the user.

19. The method of claim 17, wherein receiving the movement information comprises receiving the movement information from the movement information sensing unit that includes a camera-based sensing unit for sensing the movement information through an infrared camera or a depth camera located in the vicinity of the user.

20. The method of claim 14, wherein receiving the movement information comprises receiving the movement information from the movement information sensing unit that includes an interface unit for acquiring a space for movement of feet of the user through a treadmill located beneath the feet of the user.
